(19) United States
(12) Patent Application Publication
(10) Pub. No.: US 2012/0031274 A1
(43) Pub. Date: Feb. 9, 2012

(54) AERATION APPARATUS, SEAWATER FLUE GAS DESULPHURIZATION APPARATUS INCLUDING THE SAME, AND HUMIDIFICATION METHOD FOR AERATION APPARATUS

(75) Inventors: Keisuke Sonoda, Tokyo (JP); Shozo Nagao, Tokyo (JP)

(73) Assignee: MITSUBISHI HEAVY INDUSTRIES, LTD., Tokyo (JP)

(21) Appl. No.: 13/204,345

(22) Filed: Aug. 5, 2011

Related U.S. Application Data
(60) Provisional application No. 61/405,780, filed on Oct. 22, 2010.

(30) Foreign Application Priority Data
Aug. 6, 2010 (JP) 2010-178093

(51) Int. Cl. B01D 47/02; B05B 17/00; B01D 19/00; F24F 6/04; B01D 53/14

(52) U.S. Cl. 96/234; 261/77; 239/1

(57) ABSTRACT

An aeration apparatus is immersed in diluted used seawater which is water to be treated and generates fine air bubbles in the diluted used seawater. The aeration apparatus includes: an air supply line L₅ for supplying air 122 through blowers 121A to 121D serving as discharge unit; a fresh water tank 140 and a supply pump P₁ that are used as moisture supplying unit for supplying fresh water 141 serving as moisture to the air supply line L₅; and aeration nozzles 123 including diffuser membranes 11 having slits, through which the air containing the moisture is supplied to the aeration nozzles 123.

### TECHNICAL FIELD

The present invention relates to wastewater treatment in a flue gas desulphurization apparatus used in a power plant such as a coal, crude oil, or heavy oil combustion power plant. In particular, the invention relates to an aeration apparatus for aeration used for decarboxylation (air-exposure) of wastewater (used seawater) from a flue gas desulphurization apparatus for desulphurization using a seawater method. The invention also relates to a seawater flue gas desulphurization apparatus including the aeration apparatus and to a humidification method for the aeration apparatus.

### BACKGROUND ART

In conventional power plants that use coal, crude oil, and the like as fuel, combustion flue gas (hereinafter referred to as “flue gas”) discharged from a boiler is emitted to the air after sulfur oxides (SO_{X}) such as sulfur dioxide (SO₂) contained in the flue gas are removed. Known examples of the desulphurization method used in a flue gas desulphurization apparatus for the above desulphurization treatment include a limestone-gypsum method, spray dryer method, and seawater method.

In a flue gas desulphurization apparatus that uses the seawater method (hereinafter referred to as a “seawater flue gas desulphurization apparatus”), its desulphurization method uses seawater as an absorbent. In this method, seawater and flue gas from a boiler are supplied to the inside of a desulfurizer (absorber) having a vertical tubular shape such as a vertical substantially cylindrical shape, and the flue gas is brought into gas-liquid contact with the seawater used as the absorbent in a wet process to remove sulfur oxides. The seawater (used seawater) used as the absorbent for desulphurization in the desulfurizer flows through, for example, a long water passage having an open upper section (Seawater Oxidation Treatment System: SOTS) and is then discharged. In the long water passage, the seawater is decarbonated (exposed to air) by aeration that uses fine air bubbles ejected from an aeration apparatus disposed on the bottom surface of the water passage (Patent documents 1 to 3).

### PRIOR ART DOCUMENTS

### Patent Documents

Patent document 1: Japanese Patent Application Laid-open No. 2006-055779
Patent document 2: Japanese Patent Application Laid-open No. 2009-028570
Patent document 3: Japanese Patent Application Laid-open No. 2009-028572

### DISCLOSURE OF INVENTION

### Problem to be Solved by the Invention

Aeration nozzles used in the aeration apparatus each have a large number of small slits formed in a rubber-made diffuser membrane that covers a base. Such aeration nozzles are generally referred to as “diffuser nozzles.”These aeration nozzles can eject many fine air bubbles of substantially equal size from the slits with the aid of the pressure of the air supplied to the nozzles.

When aeration is continuously performed in seawater using the above aeration nozzles, precipitates such as calcium sulfate in the seawater are deposited on the wall surfaces of the slits of the diffuser membranes and around the openings of the slits, causing the gaps of the slits to be narrowed and the slits to be clogged. This results an increase in pressure loss of the diffuser membranes, and the discharge pressure of discharge unit, such as a blower or compressor, for supplying the air to the diffuser is thereby increased, so that disadvantageously the load on the blower or compressor increases.

The occurrence of the precipitates may be due to the following reason. Seawater present outside a diffuser membrane permeates inside the diffuser membrane through its slits and comes into continuous contact with air passing through the slits for a long time. Drying (concentration of the seawater) is thereby facilitated, and the precipitates are deposited.

In view of the above problem, it is an object of the present invention to provide an aeration apparatus that can suppress the occurrence of precipitates in the slits of diffuser membranes, a seawater flue gas desulphurization apparatus including the aeration apparatus, and a humidification method for the aeration apparatus.

### Means for Solving Problem

According to an aspect of the present invention, an aeration apparatus that is immersed in water to be treated and generates fine air bubbles in the water to be treated, the aeration apparatus includes: an air supply pipe for supplying air through discharge unit; moisture supplying unit for supplying moisture to the air supply pipe; and an aeration nozzle including a diffuser membrane having a slit, the air containing the moisture being supplied to the aeration nozzle.

Advantageously, in the aeration apparatus, the moisture is one of fresh water and seawater.

According to another aspect of the present invention, an aeration apparatus that is immersed in water to be treated and generates fine air bubbles in the water to be treated, the aeration apparatus includes: an air supply pipe for supplying air through discharge unit; water vapor supplying unit for supplying water vapor to the air supply pipe; and an aeration nozzle including a diffuser membrane having a slit, the air containing the water vapor being supplied to the aeration nozzle.

Advantageously, the aeration apparatus further includes a filter and a cooling unit that are disposed in the air supply pipe.

Advantageously, in the aeration apparatus, the moisture is supplied near an air inlet of the discharge unit.

Advantageously, in the aeration apparatus, the aeration nozzle further includes the diffuser membrane covering a support body into which the air is introduced and a large number of the slits formed therein, the fine air bubbles being ejected from the large number of slits.

According to still another aspect of the present invention, a seawater flue gas desulphurization apparatus includes: a desulfurizer that uses seawater as an absorbent; a water passage for allowing used seawater discharged from the desulfurizer to flow therethrough and be discharged; and the aeration apparatus described above that is disposed in the water passage, the aeration apparatus generating fine air bubbles in the used seawater to decarbonate the used seawater.

According to still another aspect of the present invention, a humidification method for an aeration apparatus includes: using an aeration apparatus that is immersed in water to be treated and used to generate fine air bubbles in the water to be treated; adding moisture or water vapor to air when the air is supplied through discharge unit; and supplying the air containing the moisture to a slit of a diffuser membrane.

### Effect of the Invention

According to the present invention, the occurrence of precipitates in the slits of the diffuser membranes of the aeration apparatus can be suppressed.

### BRIEF DESCRIPTION OF DRAWINGS

FIG. 1 is a schematic diagram of a seawater flue gas desulphurization apparatus according to an embodiment.

FIG. 2-1 is a plan view of aeration nozzles.

FIG. 2-2 is a front view of the aeration nozzles.

FIG. 3 is a schematic diagram of the inner structure of an aeration nozzle.

FIG. 4 is a schematic diagram of an aeration apparatus according to an embodiment.

FIG. 5 is a schematic diagram of another aeration apparatus according to the embodiment.

FIG. 6 is a schematic diagram of another aeration apparatus according to the embodiment.

FIG. 7 is a schematic diagram of another aeration apparatus according to the embodiment.

FIG. 8-1 is a diagram illustrating the states of the outflow of air (a mixture of moisture-saturated air and water mist) and the inflow of seawater in a slit of a diffuser membrane.

FIG. 8-2 is a diagram illustrating the states of the outflow of air (moisture-saturated air) and the inflow of seawater in the slit of the diffuser membrane.

FIG. 8-3 is a diagram illustrating the states of the outflow of air (humid air, relative humidity: 100% or less), the inflow of seawater, and concentrated seawater in the slit of the diffuser membrane.

FIG. 8-4 is a diagram illustrating the states of the outflow of air, the inflow of seawater, and concentrated seawater in the slit of the diffuser membrane.

FIG. 8-5 is a diagram illustrating the states of the outflow of air, the inflow of seawater, concentrated seawater, and precipitates in the slit of the diffuser membrane.

FIG. 9 is a set of graphs showing a change in the salt concentration in seawater entering the slits of aeration nozzles and the operating condition of an aeration apparatus when moisture is intermittently supplied to an air supply pipe.

### BEST MODE(S) FOR CARRYING OUT THE INVENTION

Hereinafter, the present invention will be described in detail with reference to the drawings. However, the present invention is not limited to embodiments described below. The components in the following embodiments include those readily apparent to persons skilled in the art and those substantially similar thereto.

### EMBODIMENTS

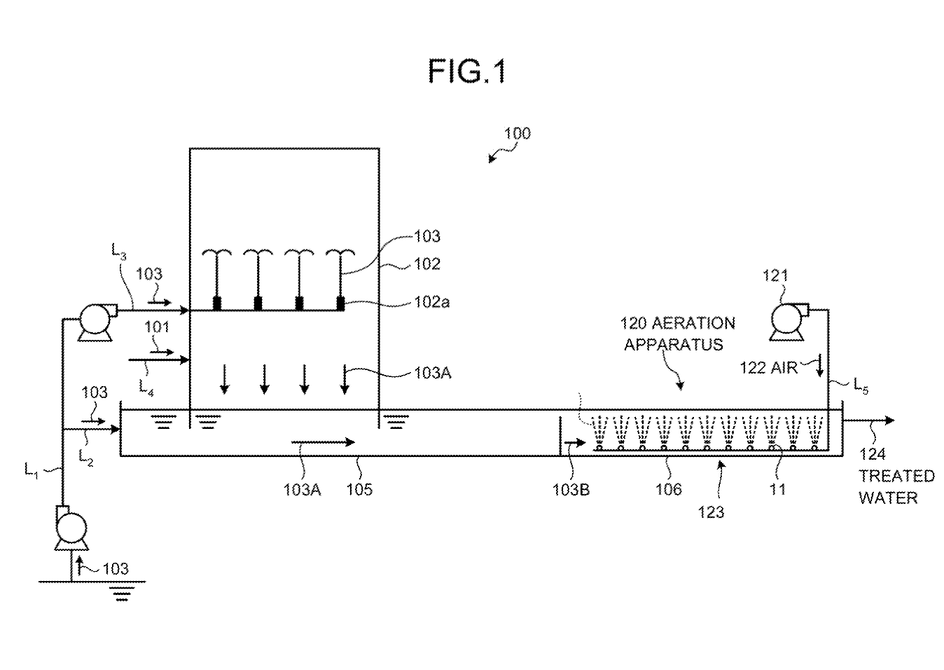

An aeration apparatus and a seawater flue gas desulphurization apparatus according to embodiments of the present invention will be described with reference to the drawings. FIG. 1 is a schematic diagram of the seawater flue gas desulphurization apparatus according to one embodiment.

As shown in FIG. 1, the seawater flue gas desulphurization apparatus 100 includes: a flue gas desulphurization absorber 102 in which flue gas 101 and seawater 103 comes in gas-liquid contact to desulphurize SO₂ into sulfurous acid (H₂SO₂); a dilution-mixing basin 105 disposed below the flue gas desulphurization absorber 102 to dilute and mix used seawater 103A containing sulfur compounds with dilution seawater 103; and an oxidation basin 106 disposed on the downstream side of the dilution-mixing basin 105 to subject the diluted used seawater 103B to water quality recovery treatment.

In the seawater flue gas desulphurization apparatus 100, the seawater 103 is supplied through a seawater supply line L₁, and part of the seawater 103 is used for absorption, i.e., is brought into gas-liquid contact with the flue gas 101 in the flue gas desulphurization absorber 102 to absorb SO₂ contained in the flue gas 101 into the seawater 103. The used seawater 103A that has absorbed the sulfur components in the flue gas desulphurization absorber 102 is mixed with the dilution seawater 103 supplied to the dilution-mixing basin 105 disposed below the flue gas desulphurization absorber 102. The diluted used seawater 103B diluted and mixed with the dilution seawater 103 is supplied to the oxidation basin 106 disposed on the downstream side of the dilution-mixing basin 105. Air 122 supplied from an oxidation air blower 121 is supplied to the oxidation basin 106 from aeration nozzles 123 to recover the quality of the seawater, and the resultant water is discharged to the sea as treated water 124.

In FIG. 1, reference numeral 102a represents spray nozzles for injecting seawater upward as liquid columns; 120 represents an aeration apparatus; 122a represents air bubbles; L₁ represents a seawater supply line; L₂ represents a dilution seawater supply line; L₃ represents a desulphurization seawater supply line; L₄ represents a flue gas supply line; and L₅ represents an air supply line.

The structure of the aeration nozzles 123 is described with reference to FIGS. 2-1, 2-2, and 3 when a diffuser membrane is made of rubber.

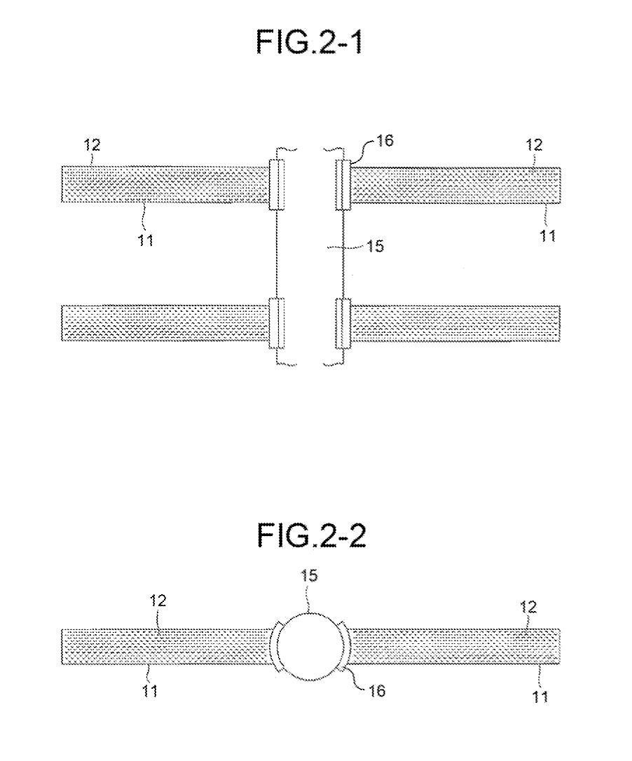

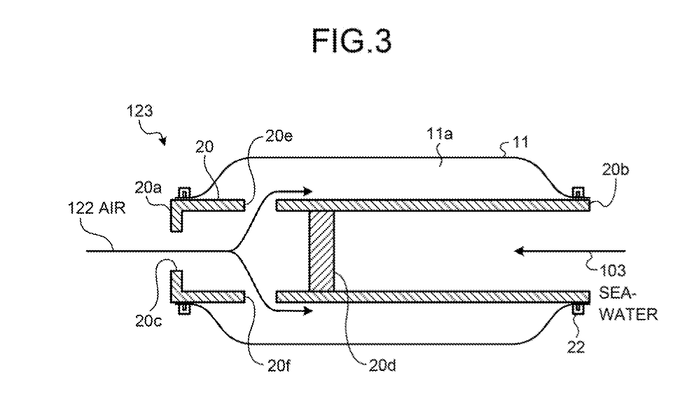

FIG. 2-1 is a plan view of the aeration nozzles; FIG. 2-2 is a front view of the aeration nozzles; and FIG. 3 is a schematic diagram of the inner structure of an aeration nozzle.

As shown in FIG. 3, each aeration nozzle 123 has a large number of small slits 12 formed in a rubber-made diffuser membrane 11 that covers the circumference of a base and is generally referred to as a “diffuser nozzle.” In such an aeration nozzle 123, when the diffuser membrane 11 is expanded by the pressure of the air 122 supplied from the air supply line L₅, the slits 12 open to allow a large number of fine air bubbles of substantially equal size to be ejected.

As shown in FIGS. 2-1 and 2-2, the aeration nozzles 123 are attached through flanges 16 to headers 15 provided in a plurality of (eight in the present embodiment) branch pipes (not shown) branched from the air supply line L₅. In consideration of corrosion resistance, resin-made pipes, for example, are used as the branch pipes and the headers 15 disposed in the diluted used seawater 103B.

For example, as shown in FIG. 3, each aeration nozzle 123 is formed as follows. A substantially cylindrical support body 20 that is made of a resin in consideration of corrosion resistance to the used seawater 103B is used, and a rubber-made diffuser membrane 11 having a large number of slits 12 formed therein is fitted on the support body 20 so as to cover its outer circumference. Then the left and right ends of the diffuser membrane 11 are fastened with fastening members 22 such as wires or bands.

The slits 12 described above are closed in a normal state in which no pressure is applied thereto.

In the seawater flue gas desulphurization apparatus 100, when the air 122 is continuously supplied, the slits 12 are constantly in an open state.

A first end 20a of the support body 20 is attached to a header 15 and allows the introduction of the air 122, and the support body 20 has an opening at its second end 20b that allows the introduction of the seawater 103.

In the support body 20, the side close to the first end 20a is in communication with the inside of the header 15 through an air inlet port 20c that passes through the header 15 and the flange 16. The inside of the support body 20 is partitioned by a partition plate 20d disposed at some axial position in the support body 20, and the flow of air is blocked by the partition plate 20d. Air outlet holes 20e and 20f are formed in the side surface of the support body 20 and disposed on the header 15 side of the partition plate 20d. The air outlet holes 20e and 20f allow the air 122 to flow between the inner circumferential surface of the diffuser membrane 11 and the outer circumferential surface of the support body, i.e., into a pressurization space 11a for pressurizing and expanding the diffuser membrane 11. Therefore, the air 122 flowing from the header 15 into the aeration nozzle 123 flows through the air inlet port 20c into the support body 20 and then flows through the air outlet holes 20e and 20f formed in the side surface into the pressurization space 11a, as shown by arrows in FIG. 3.

The fastening members 22 fasten the diffuser membrane 11 to the support body 20 and prevent the air flowing through the air outlet holes 20e and 20f from leaking from the opposite ends.

In the aeration nozzle 123 configured as above, the air 122 flowing from the header 15 through the air inlet port 20c flows through the air outlet holes 20e and 20f into the pressurization space 11a. Since the slits 12 are closed in the initial state, the air 122 is accumulated in the pressurization space 11a to increase the inner pressure. The increase in the inner pressure of the pressurization space 11a causes the diffuser membrane 11 to expand, and the slits 12 formed in the diffuser membrane 11 are thereby opened, so that fine bubbles of the air 122 are injected into the diluted used seawater 103B. Such fine air bubbles are generated in all the aeration nozzles 123 to which air is supplied through branch pipes L_{5A} to L_{5H} and the headers 15.

Aeration apparatuses according to an embodiment will next be described. The present invention provides means for avoiding deposition of precipitates such as calcium sulfate by preventing drying and concentration of seawater in the slits 12 of the diffuser membranes 11. To prevent the seawater 103 from being dried and concentrated in the slits 12 by the air 122 supplied thereto, wet air with a high moisture content (a high relative humidity) is used as the supplied air 122. Preferably, the air 122 having a high relative humidity is moisture-saturated air with a relative humidity of 100% or moisture-saturated air containing water mist, and measures are taken to obtain such air.

The present invention will next be described specifically.

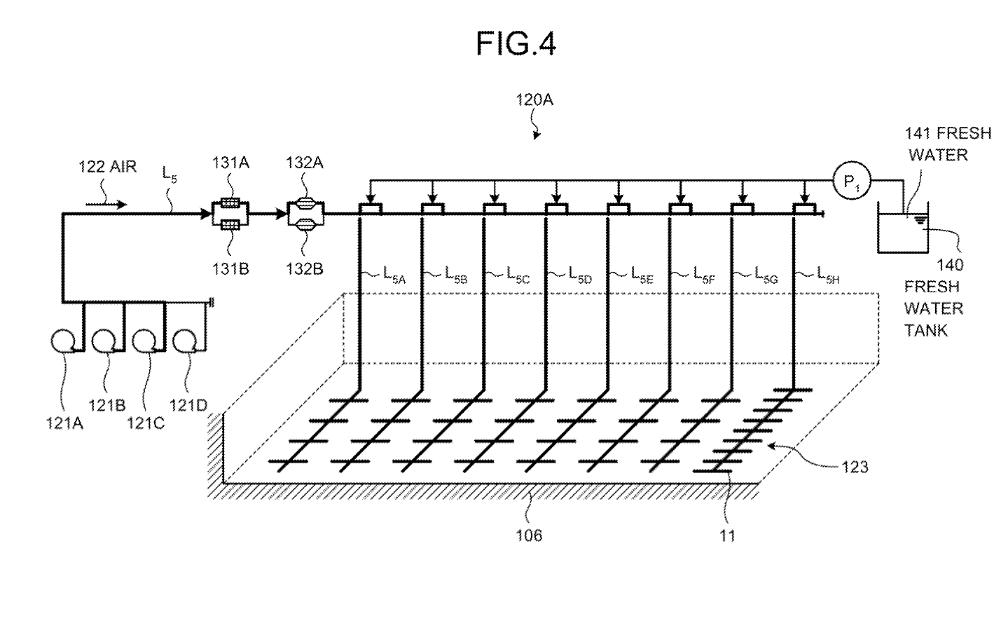

FIGS. 4 to 7 are schematic diagrams of the aeration apparatuses according to the present embodiment.

As shown in FIG. 4, an aeration apparatus 120A according to the present embodiment is immersed in diluted used seawater (not shown), which is water to be treated, and generates fine air bubbles in the diluted used seawater 103B. This aeration apparatus includes: an air supply line L₅ for supplying air 122 from blowers 121A to 121D (discharge unit); a fresh water tank 140 and a supply pump P₁, which are moisture supplying unit for supplying fresh water 141 being moisture to the air supply line L₅; and aeration nozzles 123 each including a diffuser membrane 11 having slits for supplying air containing moisture.

Two cooling units 131A and 131B and two filters 132A and 132B are provided in the air supply line L₅. The air compressed by the blowers 121A to 121D is thereby cooled and then filtrated.

Normally, three of the four blowers are used for operation, and one of them is a reserve blower. Since the aeration apparatus must be continuously operated, only one of the two cooling units 131A and 131B and only one of the two filters 132A and 132B are normally used, and the others are used for maintenance.

In the present embodiment, fresh water is used to supply moisture. However, instead of the fresh water, seawater (such as seawater 103 from the dilution seawater supply line L₂, used seawater 103A in the dilution-mixing basin 105, or diluted used seawater 103B in the oxidation basin 106) may be used.

In the present embodiment, since moisture (the fresh water 141 or seawater) is supplied, the air 122 supplied to the aeration nozzles 123 can be humidified (the partial pressure of water vapor in the air 122 can be increased).

In the aeration apparatus 120A shown in FIG. 4, moisture is supplied by spraying, for example, the fresh water 141 into the supplied air 122 using single-fluid nozzles (arrow portions in the figure).

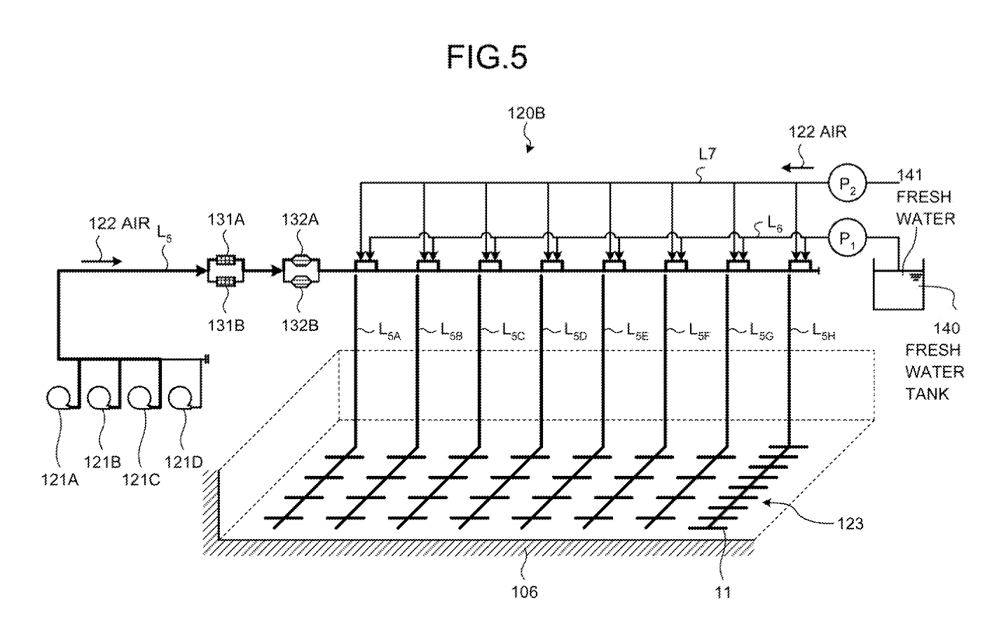

In an aeration apparatus 120B shown in FIG. 5, an air supply line L₇ is separately provided to supply air 122 to sections to which the moisture is supplied.

This air 122 is used as assist gas when the moisture (the fresh water 141 or seawater) is supplied. More specifically, the moisture is finely sprayed with the assist gas into the air 122 supplied from the air supply line L₅ using two-fluid nozzles (in order to facilitate evaporation of the moisture). Reference symbol P₂ represents an air supply pump.

In the air supply systems shown in FIGS. 4 and 5 above, the cooling units 131A and 131B may be omitted. In this case, a predetermined amount of moisture (fresh water or seawater) is injected into the air 122 pressurized by the blowers 121A to 121D and increased in temperature to reduce the temperature of the air 122 to be supplied so that the air in the slits 11 of the aeration nozzles 123 is saturated with moisture.

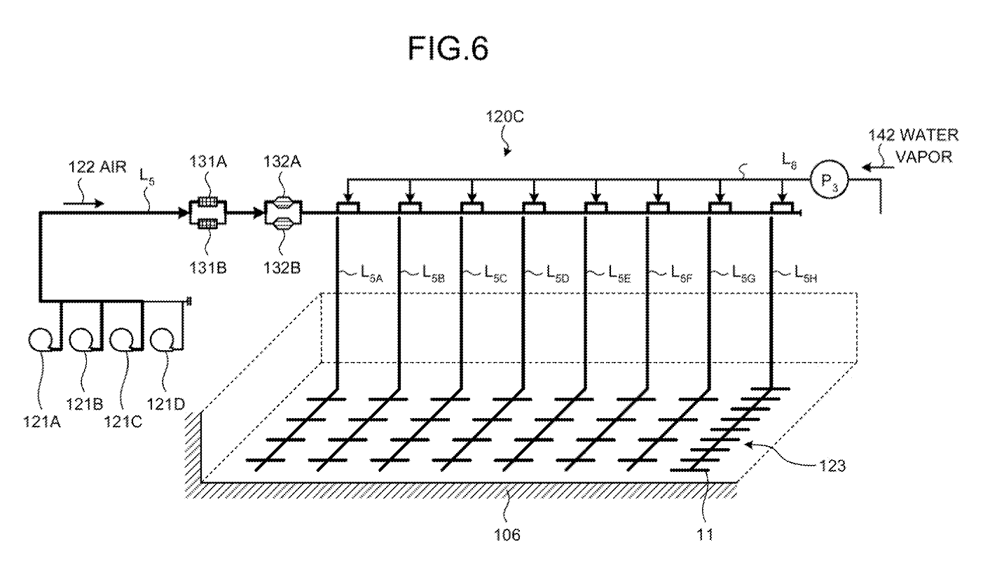

In an aeration apparatus 120C shown in FIG. 6, water vapor 142 is supplied from a water vapor supply line L₈. Reference symbol P₃ represents a water vapor supply pump.

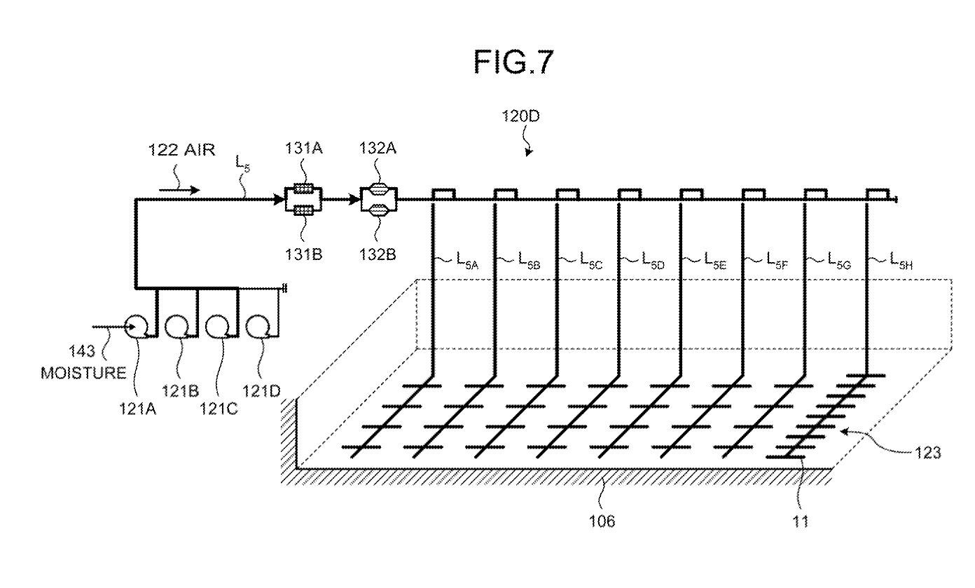

In an aeration apparatus 120D shown in FIG. 7, intake spray nozzles (not shown) for supplying moisture 143 are provided near the air inlets of the blowers 121A to 121D, which serve as discharge unit. In this case, the moisture 143 is added to intake air (the moisture is vaporized before it enters the blowers), and the amount of cooling in the cooling unit 131A on the outlet side of the blowers is controlled so that the air passing through the slits of the aeration nozzles is moisture-saturated air.

More specifically, the temperature of the air 122 pressurized and compressed by the blowers 121A to 121D is as high as, for example, about 100° C. However, when an excess amount of the moisture 143 is supplied before pressurization and compression, the air 122 to be supplied is moisture rich. Then the temperature of the air is reduced by the cooling unit 131 (to, for example, 40° C.) Since the amount of moisture in the air 122 is unchanged, the degree of moisture saturation (the relative humidity) of the cooled air 122 increases. Therefore, the relative humidity of the air in the slits 12 of the aeration nozzles 123 is 100%. When the amount of water added to the intake air is further increased, moisture-saturated air containing water mist is formed, and a gas-liquid two-phase state is formed.

Even when the relative humidity of the air sucked by the blowers 121A to 121D is 100% on the inlet side of the blowers, the relative humidity of the air in the slits 11 of the aeration nozzles 123 may not be 100% because the air is compressed and cooled. In such a case, if the shortage of the moisture 143 is supplied at the inlets of the blowers, unevaporated moisture enters the blowers, which is not preferred. In this case, moisture such as fresh water or seawater is supplied on the outlet side of the blowers 121A to 121D or the downstream side of the cooling units 131A and 131B.

When moisture is supplied to the air 122 in each of the cases shown in FIGS. 4 to 7 described above, the amount of moisture supplied and the amount of cooling in the cooling unit are adjusted according to the air conditions (pressure, temperature, and relative humidity) at the inlets of the blower and in consideration of pressure loss and heat exchange between the air supply pipe and the outside such that the air passing through the slits 11 of the aeration nozzles 123 is moisture-saturated air or moisture-saturated air entraining water mist.

As described above, moisture-saturated air or moisture-saturated air entraining water mist is supplied to the aeration nozzles 123. This prevents drying (concentration) of seawater that enters the slits 12 of the diffuser membranes 11 and thereby prevents the deposition of salts, such as calcium sulfate, in the seawater. When concentrated seawater (salt concentration: about 3.4% or more and about 14% or less) is formed in the slits, the water mist contributes to relaxation of the concentration of the seawater (a reduction in salt concentration).

By supplying moisture (fresh water, water vapor, or seawater) as described above, the air 122 supplied to the aeration nozzles 123 is saturated with water vapor. This prevents drying (concentration) of the seawater that enters the slits 12 of the diffuser membranes 11 and thereby prevents the deposition of calcium sulfate and the like. In this manner, the pressure loss of the diffuser membranes 11 can be prevented.

Preferably, the amount of moisture supplied is set such that the air passing through the slits 12 of the aeration nozzles 123 is air fully saturated with moisture. More preferably, the amount of moisture supplied is set such that the air is moisture-saturated air entraining water mist (in a gas-liquid two-phase state). The relative humidity of the air 122 flowing into the slits 12 of the aeration nozzles 123 is 40% or more, preferably 60% or more, and more preferably 80% or more. Conditions under which the concentrating rate of seawater in the slits is slow may be used depending on the maintenance time of the apparatus.

The humidity condition of the air passing through the slits 12 of the aeration nozzles 123 is controlled by adjusting the humidity of air sucked by the blowers, the amount of moisture supplied, the amount of cooling in the cooling unit, and the like.

In this manner, the seawater entering the slits 12 of the diffuser membrane 11 is prevented from being dried, and the degree of concentration of the seawater (an increase in salt concentration) is suppressed, so that the salt concentration in the seawater can be maintained at about 14% or less.

The salt concentration in seawater is generally about 3.4%, and 3.4% of salts are dissolved in 96.6% of water. The salts include 77.9% of sodium chloride, 9.6% of magnesium chloride, 6.1% of magnesium sulfate, 4.0% of calcium sulfate, 2.1% of potassium chloride, and 0.2% of other salts.

Of these salts, calcium sulfate is deposited first as seawater is concentrated (dried), and the deposition threshold value of the salt concentration in seawater is about 14%.

Therefore, by injecting moisture such as the fresh water 141 into the air 122 to be supplied to the aeration nozzles 123 by the moisture supplying unit to form moisture-rich air and then supplying the moisture-rich air to the slits 12 of the diffuser membranes 11, the concentration of the seawater (an increase in the salt concentration) in the slits 12 can be prevented, and the deposition of calcium sulfate and the like can thereby be prevented.

This can prevent the narrowing of the gaps of the slits 12 due to the deposition of calcium sulfate and the like and the clogging of the slits 12, and the pressure loss of the diffuser membranes 11 can thereby be prevented.

FIGS. 8-1 to 8-5 are diagrams illustrating the outflow of air (to which moisture has been supplied) and the inflow of the seawater 103 in a slit 12 of a diffuser membrane 11.

In the present invention, the slits 12 are cuts formed in the diffuser membranes 11, and the gap of each slit 12 serves as a discharge passage of air.

The seawater 103 is in contact with slit wall surfaces 12a that form the passage. The introduction of the air 122 causes the seawater 103 to be dried and concentrated to form concentrated seawater 103a. Then a precipitate 103b is deposited on the slit wall surfaces and clogs the passage in the slit.

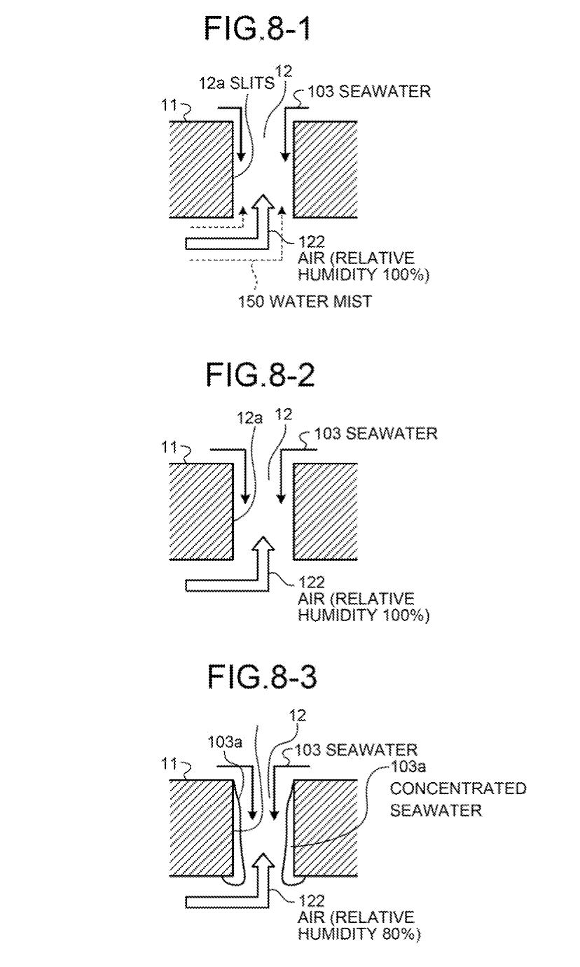

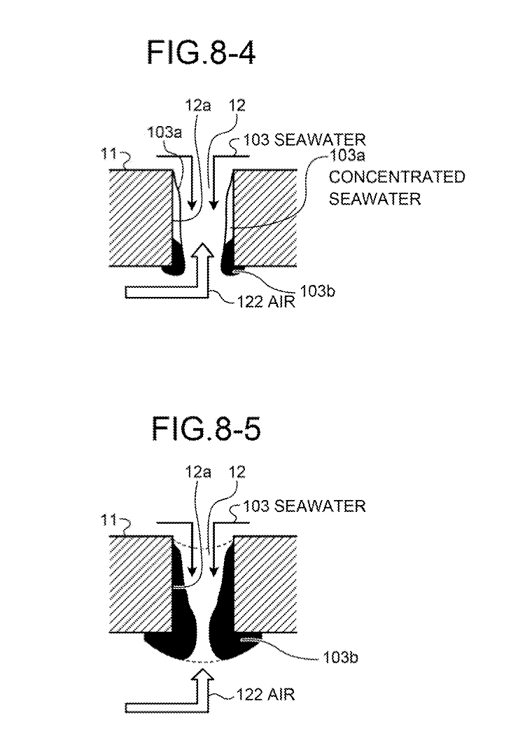

In the state shown in FIG. 8-1, the relative humidity of the air 122 is 100% (moisture-saturated air), and the air 122 entrains water mist 150 to form a gas-liquid two-phase state. Therefore, the seawater 103 entering the slit 12 is not dried (concentrated), and the salt concentration is reduced, so that the drying (concentration) of the seawater is prevented.

In the state shown in FIG. 8-2, the relative humidity of the air 122 is 100%. Therefore, the salt concentration in seawater is unchanged, and the drying of the seawater is prevented.

In the state shown in FIG. 8-3, the relative humidity of the air 122 is, for example, 80%. Therefore, the drying of the seawater is suppressed. The salt concentration in the seawater increases gradually, and concentrated seawater 103a is formed. However, even if the concentration of the seawater is initiated, deposition of calcium sulfate and the like does not occur when the salt concentration in the seawater is about 14% or less. Therefore, in this state, by intermittently introducing moisture-saturated air entraining water mist 150 to force the formation of a moisture-rich state, the salt concentration increased to some extent is reduced, and the deposition is thereby avoided. In this manner, the apparatus can be operated for a long time.

FIGS. 8-4 and 8-5 show the growth states of the precipitate in the slit 12 of the diffuser membrane 11 as the drying and concentration of the seawater due to the air proceed.

In the state shown in FIG. 8-4, the precipitate 103b is generated in portions of the concentrated seawater 103a in which the salt concentration in the seawater locally exceeds 14%. In this state, the amount of the precipitate 103b is very small. Therefore, although the pressure loss when the air 122 passes through the slit increases slightly, the air can pass through the slit.

However, in the state shown in FIG. 8-5, since the concentration of the concentrated seawater 103a has proceeded further, a clogged (plugged) state due to the precipitate 103b is formed, and the pressure loss is high. Even in this state, the passage of the air 122 remains present, but the load on the discharge unit is considerably large.

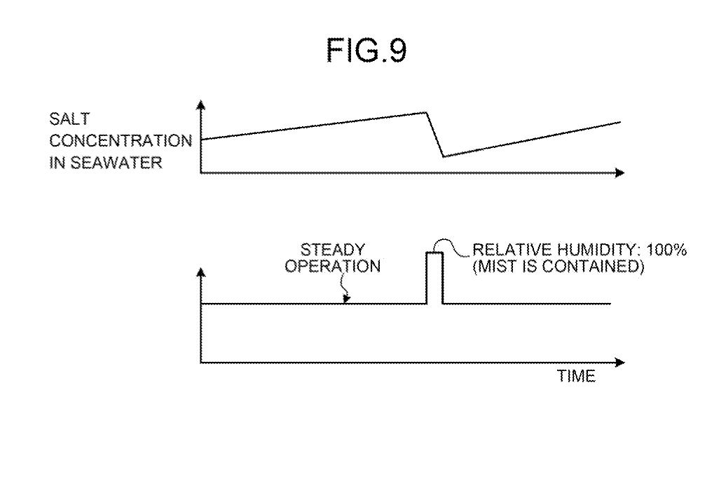

FIG. 9 is a set of graphs showing a change in the salt concentration in seawater and the operating condition of an aeration apparatus.

As shown in FIG. 9, when air with a relative humidity of 100% or less is supplied, moisture-rich moisture-saturated air having a humidity of 100% and containing water mist 150 or moisture-saturated air entraining water mist is intermittently introduced after normal operation is performed for a predetermined time (the introduction period is illustrated as a peak). In this manner, the operation can be performed without deposition of calcium sulfate and the like.

In the present embodiment, plugging caused by deposition of seawater components and contamination components such as sludge on diffuser slits (membrane slits) can be prevented in the aeration apparatuses for aeration of seawater. Therefore, an increase in pressure loss in the aeration apparatuses can be prevented, and the aeration apparatuses can be stably operated for a long time.

In the description in the present embodiment, seawater is exemplified as water to be treated, but the invention is not limited thereto. For example, in an aeration apparatus for aerating polluted water in polluted water treatment (such as sewage treatment), plugging caused by deposition of contamination components such as sludge on diffuser slits (membrane slits) can be prevented, and the aeration apparatus can be stably operated for a long time.

In the description of the present embodiment, tube-type aeration nozzles are used in the aeration apparatuses, but the present invention is not limited thereto. For example, the invention is applicable to disk-type and flat-type aeration apparatuses having diffuser membranes and to diffusers including ceramic or metal diffuser membranes having slits that are open at all times.

### INDUSTRIAL APPLICABILITY

As described above, in the aeration apparatus according to the present invention, the occurrence of precipitates in the slits of the diffuser membranes of the aeration apparatus can be suppressed. For example, when applied to a seawater flue gas desulphurization apparatus, the aeration apparatus can be continuously operated in a stable manner for a long time.

### EXPLANATIONS OF LETTERS OR NUMERALS

11 diffuser membrane
12 slit
100 seawater flue gas desulphurization apparatus
102 flue gas desulphurization absorber
103 seawater
103a concentrated seawater
103b precipitate
103A used seawater
103B diluted used seawater
105 dilution-mixing basin
106 oxidation basin
120A to 120D aeration apparatus
122 air
123 aeration nozzle

1. An aeration apparatus that is immersed in water to be treated and generates fine air bubbles in the water to be treated, the aeration apparatus comprising:
an air supply pipe for supplying air through discharge unit;
moisture supplying unit for supplying moisture to the air supply pipe; and
an aeration nozzle including a diffuser membrane having a slit, the air containing the moisture being supplied to the aeration nozzle.

2. The aeration apparatus according to claim 1, wherein
the moisture is one of fresh water and seawater.

3. An aeration apparatus that is immersed in water to be treated and generates fine air bubbles in the water to be treated, the aeration apparatus comprising:
an air supply pipe for supplying air through discharge unit;
water vapor supplying unit for supplying water vapor to the air supply pipe; and
an aeration nozzle including a diffuser membrane having a slit, the air containing the water vapor being supplied to the aeration nozzle.

4. The aeration apparatus according to claim 1, further comprising a filter and a cooling unit that are disposed in the air supply pipe.

5. The aeration apparatus according to claim 4, wherein the moisture is supplied near an air inlet of the discharge unit.

6. The aeration apparatus according to claim 1, wherein
the aeration nozzle further includes the diffuser membrane covering a support body into which the air is introduced and
a large number of the slits formed therein, the fine air bubbles being ejected from the large number of slits.

7. A seawater flue gas desulphurization apparatus, comprising:
a desulfurizer that uses seawater as an absorbent;
a water passage for allowing used seawater discharged from the desulfurizer to flow therethrough and be discharged; and
the aeration apparatus according to claim 1 that is disposed in the water passage, the aeration apparatus generating fine air bubbles in the used seawater to decarbonate the used seawater.

8. A humidification method for an aeration apparatus, comprising:
using an aeration apparatus that is immersed in water to be treated and used to generate fine air bubbles in the water to be treated;
adding moisture or water vapor to air when the air is supplied through discharge unit; and
supplying the air containing the moisture to a slit of a diffuser membrane.
